(19) United States
(12) Patent Application Publication
(10) Pub. No.: US 2026/0192768 A1
(43) Pub. Date: Jul. 9, 2026

(54) VEHICLE AIRBAG DEVICE

(71) Applicant: AUTOLIV DEVELOPMENT AB, Vargarda (SE)

(72) Inventors: Ryota ISHIGAKI, Kanagawa (JP); Yumi SHIGA, Kanagawa (JP)

(21) Appl. No.: 18/868,602

(22) PCT Filed: May 1, 2023
(86) PCT No.: PCT/JP2023/017033

§ 371 Date: Nov. 22, 2024

(30) Foreign Application Priority Data
May 27, 2022 (JP) 2022-087173

(51) Int. Cl. B60R 21/203; B60R 21/2338; B60R 21/235

(52) U.S. Cl. CPC B60R 21/2035; B60R 21/2338; B60R 21/235; B60R 2021/23382; B60R 2021/23538

(57) ABSTRACT

An airbag cushion of a vehicle airbag device has a bottom surface on the structure side, a restraining surface on the occupant side, a side surface connecting the bottom surface and the restraining surface, and a recess part formed in a prescribed range in the center of the restraining surface, recessed in the direction of the bottom surface. The range extending from the side surface of the airbag cushion to at least a portion of the restraining surface is formed by a side panel. The side panel includes a plurality of subpanels that are divided in the circumferential direction of the side surface. Each of the subpanels has a pair of side edges, joined to an adjacent subpanel, a first edge on the restraining surface side, and a second edge on the bottom surface side. The first edge is shorter than the second edge.

### TECHNICAL FIELD

The present invention relates to a vehicle airbag device for restraining an occupant in an emergency.

### BACKGROUND ART

Airbag devices have generally become standard equipment in vehicles in recent years. For example, many vehicles are equipped with a driver airbag in their steering wheels. The airbag cushion of the driver seat airbag device is primarily stored in a center portion of a steering wheel and cleaves a resin cover and the like by expansion pressure, so as to expand and deploy toward the front of an occupant.

More efficient restraint of an occupant is desired for the airbag cushion described above. The inventors of the present application focused on the fact that, based on body structure, rotation of a head of the occupant tends to cause strain on the body, and have developed an airbag cushion that enables efficient restraint while suppressing rotation of the head of the occupant.

For example, it has been found that in the case of an oblique collision that is a collision at an angle relative to the direction of travel, the occupant enters the airbag cushion at an angle and the head easily rotates. In light of the foregoing, the present applicant has developed technology for forming a recess part 120 using an internal tether 122 at the center of an airbag cushion 104 on the occupant side as disclosed in FIG. 2 of Patent Document 1, for example.

### RELATED ART DOCUMENTS

### Patent Documents

Patent Document 1: Japanese Unexamined Patent Application 2020-37382

### SUMMARY OF THE INVENTION

### Problem to Be Solved by the Invention

With the technology of Patent Document 1, a center base material 118, three internal tethers 122, and the like are used to form a recess part 120. Currently, development is underway on technology for forming a recess part more efficiently.

In light of the foregoing, an object of the present invention is to provide a vehicle airbag device that can suppress injury values of the occupant by using a simple configuration.

### Means for Solving the Problem

In order to solve the above problems, a representative configuration of a vehicle airbag device according to the present invention is a vehicle airbag device, containing an airbag cushion that is inflated and deployed between a structure in a vehicle cabin and an occupant seated in a seat in the event of an emergency, and an inflator that is installed on the structure, the airbag cushion comprising: a bottom surface on the structure side; a restraining surface on an occupant side; a side surface connecting the bottom surface and the restraining surface; and a recess part formed in a prescribed range at a center of the restraining surface recessed in the direction of the bottom surface, wherein a range extending from the side surface to at least a portion of the restraining surface is formed by a prescribed side panel; the side panel includes a plurality of subpanels divided in a circumferential direction of the side surface; each of the plurality of subpanels comprises: a pair of side edges joined to adjacent subpanels; a first edge on the restraining surface side; and a second edge on the bottom surface side; and the first edge is shorter than the second edge.

With the above configuration, a recess part is formed in the center of the restraining surface, so when an occupant enters the airbag cushion at an angle due to an oblique collision or the like, rotation of the head, for example, can be suppressed compared to when the occupant is simply restrained on a flat surface. Therefore, with the above-described configuration, it is possible to restrain the driver and suppress injury value.

Furthermore, in the above configuration, the first edge of the subpanel on the restraining surface side is shorter than the second edge on the bottom surface side, so that when the side edges of the subpanel are connected to form a side panel, the side panel has a narrowed shape on the restraining surface side. The side panel allows the recess part to be efficiently formed on the restraining surface. In addition, the side panel has a simple configuration and requires use of less material, which reduces costs by reducing weight and improving material yield, and also enables folding the airbag cushion more compactly for storage.

The subpanel may form a range extending from the side surface to the recess part of the restraining surface.

The aforementioned configuration also enables forming an airbag cushion having a recess part in the restraining surface.

Each of the plurality of subpanels may be joined to an adjacent subpanel by sewing.

The aforementioned configuration also enables forming an airbag cushion having a recess part in the restraining surface.

The bottom surface of the airbag cushion may be formed by a prescribed bottom surface side panel, and a second edge may be joined to an edge of the bottom surface side panel.

The aforementioned configuration also enables forming an airbag cushion having a recess part in the restraining surface.

The inflator may be inserted into the airbag cushion with a portion penetrating the bottom surface side panel, and the airbag cushion may further have a tether that pulls the recess part toward the inflator.

The above configuration can efficiently form and maintain the recess part in a recessed state, by pulling the recess part by the tether.

The center bottom of the recess part of the airbag cushion may be formed by a prescribed center panel, wherein the first edge is joined to an edge of the center panel; and the tether extends between the center panel and the inflator or a prescribed location in the periphery of the inflator.

The above configuration can efficiently form and maintain the recess part in a recessed state, by pulling on the center panel by the tether.

The structure may be a steering wheel of a vehicle, the inflator may be located in a center proximal portion of the steering wheel, and the airbag cushion may be rolled or folded and housed in the center proximal portion.

With the above configuration, a driver airbag is realized, enabling appropriately restraining the driver.

The pair of side edges of the subpanel may be configured to protrude and curve in directions away from each other. Even with this configuration, a side panel having a narrower shape on the restraining surface side can be suitably formed by connecting the side edges of the subpanels together.

The subpanel may be widest on the second edge. Even with this configuration, a side panel having a narrower shape on the restraining surface side can be suitably formed by connecting the side edges of the subpanels together.

The sub-panel may have a widest intermediate portion formed between the first edge and the second edge. Even with this configuration, a side panel having a narrower shape on the restraining surface side can be suitably formed by connecting the side edges of the subpanels together.

### Effect of the Invention

The present invention can provide a vehicle airbag device with a simple configuration that can reduce injury values of an occupant.

### BRIEF DESCRIPTION OF THE DRAWINGS

FIG. 1 is a diagram depicting the outline of a vehicle airbag device according to an embodiment of the present invention.

FIG. 2 is a view depicting the airbag cushion in FIG. 1(b) from each direction during expansion and deployment.

FIG. 3 is a diagram depicting each panel configuring an airbag cushion in FIG. 2(a).

FIG. 4 is a diagram depicting the panels of FIG. 3(b) in an unfolded state on a plane.

FIG. 5 is various cross-sectional views of the airbag cushion of FIG. 1(b).

FIG. 6 is a diagram depicting the process of the airbag cushion of FIG. 1(b) restraining the driver in an oblique collision.

FIG. 7 is a diagram depicting a modified example of the subpanels depicted in FIG. 4(d).

### DESCRIPTION OF THE PREFERRED EMBODIMENTS

Preferred embodiments according to the present invention will hereinafter be described in detail with reference to the attached drawings. Dimensions, materials, other specific numerical values, and the like indicated in the embodiments are merely examples for ease of understanding of the invention and do not limit the present invention unless otherwise noted. Note that in the present specification and drawings, elements having essentially identical functions and configurations are labeled with identical symbols in order to omit redundant descriptions, and illustrations of elements not directly related to the present invention are omitted.

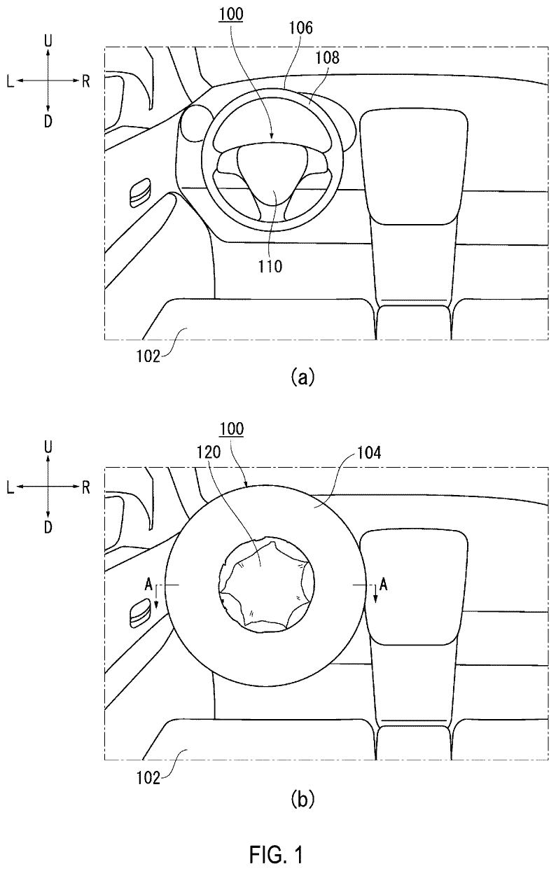

FIG. 1 depicts an overview of the vehicle airbag device (hereinafter, airbag device 100) according to the embodiment of the present invention. FIG. 1(a) is a diagram depicting a state of the airbag device 100 before activation. As depicted in FIG. 1(b), the vehicle airbag device 100 is implemented as a driver airbag for a driver seat 102 on a front row left side in a left-hand drive vehicle.

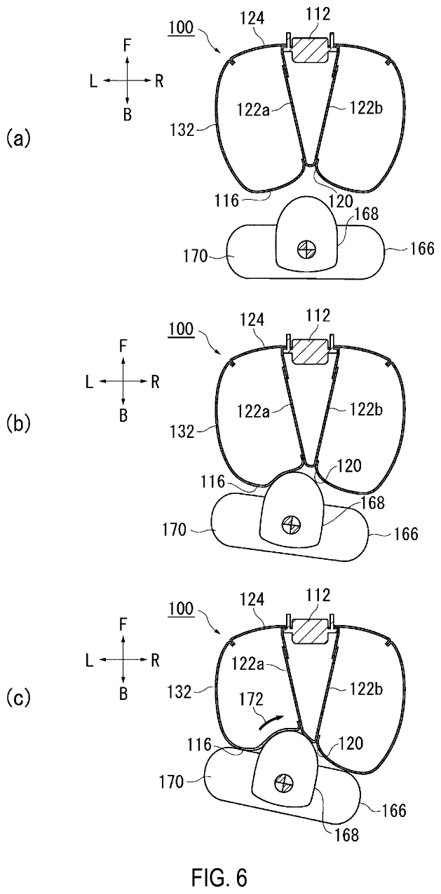

In the present embodiment, when a driver 166 (see FIG. 6(a)) is seated in a regular posture in the driver seat 102, the direction the driver 166 is facing is referred to as forward, the opposite direction is referred to as rearward, and the directions are referred to as the front-to-back direction when axes on coordinates are depicted. In addition, when the driver 166 is seated in the driver seat 102 in a regular posture, the right side of the driver 166 is referred to as the right direction, the left side of the driver 166 is referred to as the left direction, and the directions are referred to as the left-right direction when axes on coordinates are depicted. Furthermore, when the driver 166 is seated in a regular posture, the head direction of the driver 166 is referred to as up, the waist direction of the driver 166 is referred to as down, and the directions are referred to as the up-down direction when axes on coordinates are depicted.

In the drawings used in the description of embodiments of the present invention below, as necessary, the front, back, left, right, up, and down directions are indicated by arrows F (Forward), B (Back), L (Left), R (Right), U (up), and D (down), with reference to the driver 166 described above (refer to FIG. 6(a)).

In the airbag device 100 depicted in FIG. 1(a), the airbag cushion 104 is inflated and deployed between the vehicle cabin structure and the driver seated in the seat in the event of an emergency, protecting the driver from contact with the structure. As described above, in the present embodiment, the airbag device 100 is implemented as a driver airbag, and the airbag cushion 104 restrains the driver 166 (see FIG. 6(c)) to protect from contact with the steering wheel 106, from being thrown out through the windshield, or the like.

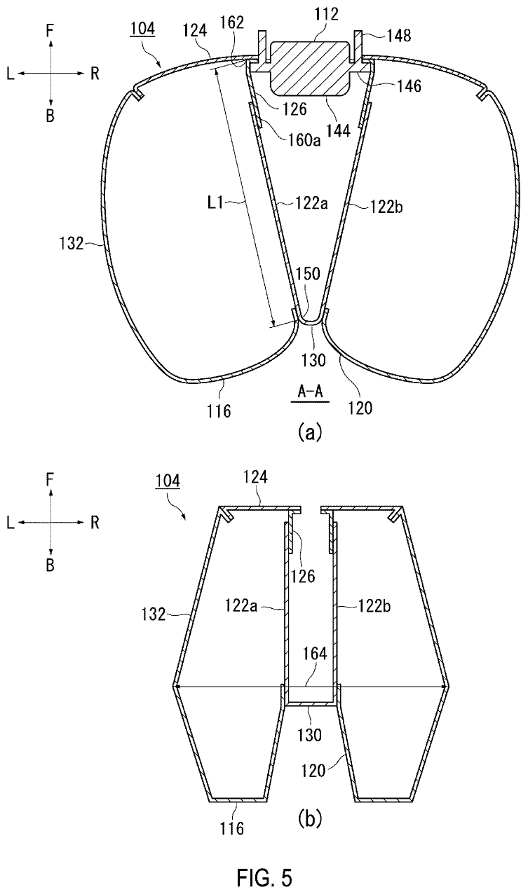

The airbag cushion 104 is a bag shaped member that can be expanded using gas, that is made compact for stowing by being rolled or folded, and is then stowed together with an inflator 112 (see FIG. 5) in a storage part 110 provided proximal to the center of the steering wheel 106.

The storage part 110 is provided closer to the center side than the rim 108 of the steering wheel 106. The storage part 110 has a groove-like tear line or the like provided on the inside of a resin cover on the surface, and the tear line is designed to tear the airbag cushion 104 (see FIG. 1(b)) during inflation and deployment.

FIG. 1(b) is a diagram depicting a state of the airbag device 100 after activation. The airbag cushion 104 inflates and deploys toward the driver 166 (see FIG. 6) in the driver's seat 102 by cleaving the cover of the storage part 110 due to the inflation pressure of the gas from the inflator 112 (see FIG. 5), and restrains the upper body and head of the driver 166 from moving forward.

The airbag cushion 104 is a round shape from the perspective of the driver seat, and expands and deploys in a shape with a recess part 120 formed at the center. The airbag cushion 104 is formed by sewing or adhering a plurality of panels to form a surface.

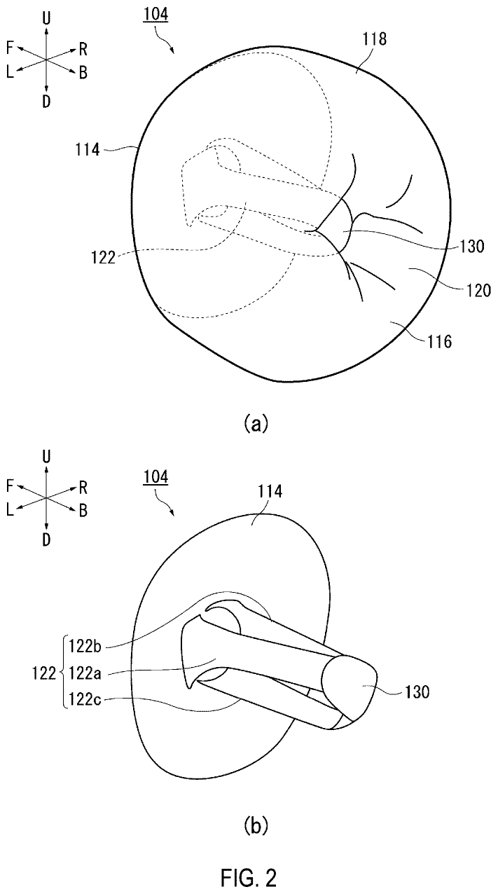

FIG. 2 is a view depicting the airbag cushion 104 in FIG. 1(b) from each direction during expansion and deployment. FIG. 2(a) depicts the airbag cushion 104 of FIG. 1(b) viewed from slightly above the exterior of the vehicle.

The airbag cushion 104 expands and deploys into a shape that approximates a rounded cylinder. The surface of the airbag cushion 104 is roughly divided and formed from a bottom surface 114 on the steering wheel 106 (see FIG. 1(a)) side, a restraining surface 116 on the occupant side, and a side surface 118 connecting the bottom surface 114 and the restraining surface 116.

The airbag cushion 104 has a recess part 120 recessed in the center of the restraining surface 116 as a characteristic site. The recess part 120 is used to suppress rotation of a head 168 of the driver 166 when restraining an occupant, as depicted in FIG. 6 below.

The recess part 120 is formed by a tether 122 provided inside the airbag cushion 104 pulling a panel forming the restraining surface 116 of the airbag cushion 104 in the direction of the bottom surface 114.

FIG. 2(b) is a figure exposing and depicting the tethers 122 from FIG. 2(a). The tethers 122 are belt-shaped components, and there are 3 provided in total (1st tether 122a, 2nd tether 122b, and 3rd tether 122c). A first end of the tether 122 is connected to the center panel 130 on the restraining surface side inside the airbag cushion 104, and a second end is connected to a location on the bottom surface 114 side inside the airbag cushion 104.

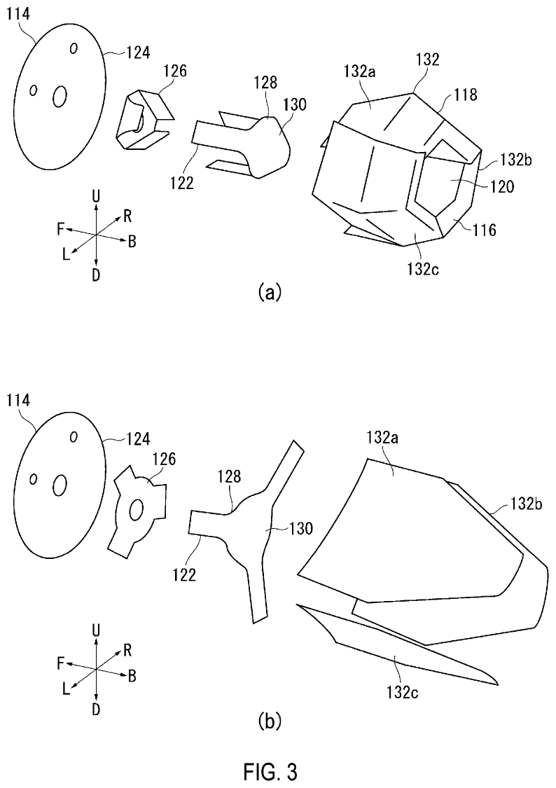

FIG. 3 is a diagram depicting each panel configuring an airbag cushion 104 in FIG. 2(a). FIG. 3(a) is an exploded view of the panels of the airbag cushion 104 of FIG. 2(a).

The bottom surface 114 of the airbag cushion 104 is formed by a bottom surface side panel 124. The inner panel 126 is provided over the bottom surface side panel 124 inside the airbag cushion 104 and is connected to the tether 122.

A composite panel 128 is a panel in which the tether 122 and the center panel 130 are integrated together. The center panel 130 is a portion that is provided at the center of the restraining surface 116 (see FIG. 2(a)), and forms the middle bottom of the recess part 120. The tether 122 extends from the center panel 130 in a trifurcated manner and is joined to the inner panel 126.

The side panel 132 is a panel that forms a region extending from the side surface 118 to the inner wall of the recess part 120 of the restraining surface 116, and is joined to the bottom surface side panel 124 and the center panel 130.

FIG. 3(b) is a diagram depicting the panels of FIG. 3(a) in an unfolded state. Of these, the side panel 132 is formed by a plurality of subpanels 132a to 132c divided in the circumferential direction of the side surface 118. In the present embodiment, the side panel 132 is formed by combining three subpanels 132a to 132c. Each of the subpanels 132a to 132c has the same polygonal configuration. These sub-panels 132a to 132c form a range extending from the side surface 118 of the airbag cushion 104 to the inner wall of the recess part 120 in the restraining surface 116.

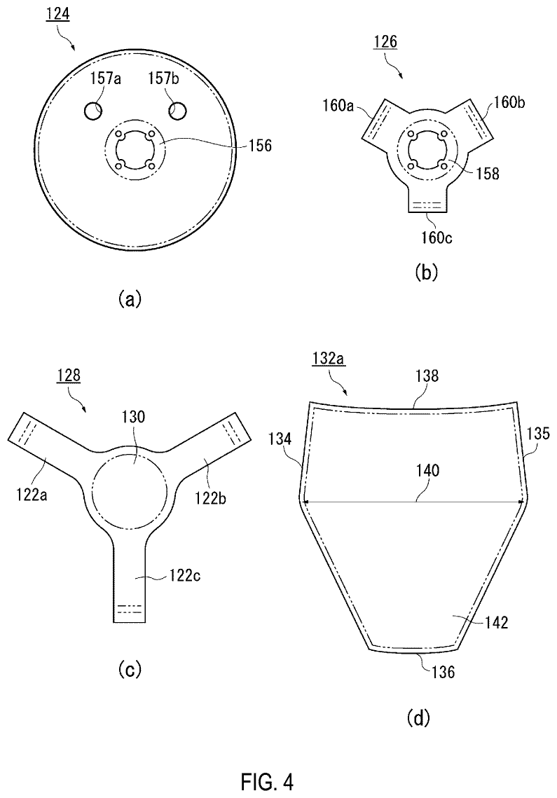

FIG. 4 is a diagram depicting the panels of FIG. 3(b) in an unfolded state on a plane. FIG. 4(a) is a diagram depicting the bottom surface side panel 124 of FIG. 3(b).

The bottom surface side panel 124 is circular and forms a reaction surface that captures reaction forces from the steering wheel 106 (see FIG. 1(a)) during inflation and deployment of the airbag cushion 104. A securing region 156 is formed in the center of the bottom surface side panel 124 as a region where the inflator 112 (see FIG. 5) is inserted and secured to the storage part 110 (see FIG. 1(a)). In addition, vent holes 157a, 157b are provided as sites for discharging gas to the outside.

FIG. 4(b) is a diagram depicting the inner panel 126 of FIG. 3(b). The inner panel 126 is overlapped with the securing region 156 of the bottom surface side panel 124, and a securing region 158 is formed as a portion into which the inflator 112 (see FIG. 5) is inserted. In addition, three protruding parts 160a to 160c are formed as sites where the three tethers 122a to 122c are joined.

FIG. 4(c) is a diagram depicting the composite panel 128 of FIG. 3(b). The composite panel 128 has a trifurcated shape with three band-like tethers 122a to 122c extending from a circular center panel 130. The center panel 130 is circular and forms the inner bottom of the recess part 120 (see FIG. 2(a)). The tethers 122a to 122c extend radially from the edge of the circular center panel 130 and are joined by sewing or the like to protruding parts 160a to 160c of the inner panel 126, respectively.

Note that the shape of the center panel 130 is not limited to a circle, but may be a polygon, or the like. In addition, the tethers 122a to 122c are not limited to being formed integrally with the center panel 130, but may be formed as separate members and then connected to the center panel 130. Either configuration allows the center panel 130 to be pulled in the direction of the bottom surface side panel 124.

FIG. 4(d) is a diagram depicting the subpanel 132a of FIG. 3(b). The subpanels 132a to 132c have a polygonal shape. A pair of left and right side edges 134, 135 of the subpanel 132a are joined to adjacent subpanels 132b, 132c (see FIG. 3(b)) by sewing or the like.

The first edge 136 is the edge on the side of the restraining surface 116 (see FIG. 2(a)), and is joined to the edge of the circular inner panel 126 (FIG. 4(c)) by sewing or the like. The second edge 138 is the edge on the bottom surface 114 (see FIG. 2(a)) side, and is joined to the edge of the circular bottom surface side panel 124 (see FIG. 4(a)) by sewing or the like. The first edge 136 and the second edge 138 are slightly curved to conform to the shape of the center panel 130 and the bottom surface side panel 124.

The subpanel 132a protrudes at an angle from an intermediate position on the side edges 134, 135, and is widest at a location slightly toward the second edge 138 side than the center between the first edge 136 and the second edge 138 (intermediate portion 140). At this time, the dimension from the first edge to the second edge 138 of the subpanel 132 a is set to be longer than the dimension of the intermediate portion 140.

A tapered region 142 from the intermediate portion 140 to the first edge 136 gradually narrows toward the first edge 136. The tapered region 142 is pulled towards the bottom surface side panel 124 (see FIG. 3(a)) by the tether 122.

In the present embodiment, the subpanel 132a is formed with the first edge 136 shorter than the second edge 138. With these configurations, when the side edges 134, 135 of the subpanel 132a are joined together to form the side panel 132, as depicted in FIG. 3(a), the side panel 132 has a narrowed shape on the restraining surface 116 side. The side panel 132 allows the recess part 120 to be efficiently formed on the restraining surface 116.

Furthermore, with this side panel 132, the subpanels 132a to 132c having the aforementioned configuration enable forming the recess part 120 while simplifying the configuration, thereby reducing the amount of material used, reducing costs by reducing weight and improving material yield, and also enabling the airbag cushion 104 to be folded more compactly for storage.

FIG. 5 provides various cross-sectional views of the airbag cushion 104 of FIG. 1(b). FIG. 5 is a cross-sectional view of the airbag cushion 104 in FIG. 1(b) along A-A. The internal configuration of the airbag cushion 104 is described below.

As described above, the airbag cushion 104 is able to efficiently form and maintain the recess part 120 in a recessed state by pulling the recess part 120 toward the inflator 112 by the tether 122.

The inflator 112 is a gas generating device that is secured to the bottom of the storage part 110 (see FIG. 1(a)). A portion thereof having a gas outlet penetrates the bottom surface side panel 124 and is inserted into the airbag cushion 104.

Upon receiving a detection signal sent from a sensor (not depicted), the inflator 112 is activated, and thereby supplies gas to the airbag cushion 104. The inflator 112 is disk-shaped and has a cylindrical main body 144 having an ejection port, and a flange 146 provided on the outer periphery of the main body 144.

The inflator 112 is provided with a plurality of stud bolts 148. The stud bolts 148 pass through the bottom surface side panel 124 of the airbag cushion 104 and are fastened to the bottom of the storage part 110 (see FIG. 1(a)). The airbag cushion 104 is also secured to the storage part 110 by fastening the stud bolts 148.

Note that examples of currently prevailing inflators include: types which are filled with a gas generating agent and burn the agent to generate gas; types which are filled with compressed gas and supply gas without generating heat; hybrid types which utilize both combustion gas and compressed gas; and the like. Any of these types can be used for the inflator 112.

Each tether, such as tether 122a, is routed between the center panel 130 and the inner panel 126 around the periphery of the inflator 112. A dimension L1 from a base 150 of the tether 122a on the center panel 130 side to a base 162 of the protruding part 160a of the inner panel 126 is formed to be a dimension that creates tension between the center panel 130 and the inner panel 126, in other words, between the center panel 130 and the inflator 112, when the airbag cushion 104 is expanded and deployed, allowing the center panel 130 to be pulled toward the inflator 112. The recess part 120 recessed toward the bottom surface 114 in the restraining surface 116 can be efficiently formed and maintained by using the tether 122 having this configuration.

Note that, in another embodiment, the tip of the tether 122 can be appropriately connected to the inflator 112, a retainer (not depicted) used to secure the inflator 112, as well as the bottom or the like of the storage part 110 (see FIG. 1(a)), and the bottom surface 114 side of the airbag cushion 104.

FIG. 5(b) is a schematic diagram depicting only the panel of the airbag cushion 104 of FIG. 5(a). When the side panel 132 is formed by combining subpanels 132a having the shape depicted in FIG. 4(d), the side panel 132 is not simply cylindrical, but has a shape that gradually widens towards the driver side. At this time, the airbag cushion 104 in FIG. 5(b) also has a maximum diameter part 164 where the diameter is a maximum, formed by the intermediate portion 140 in FIG. 4(d).

The position of the maximum diameter part 164 can be adjusted by changing the position of the intermediate portion 140 of the subpanel 132a (see FIG. 4(d)) between the first edge 136 and the second edge 138. The portion of the side panel 132 from the maximum diameter part 164 to the center panel 130 of the recess part 120 has a small radius of curvature and tends to have low tension, enabling more softly restraining the driver 166 (see FIG. 6(c)).

FIG. 6 is a diagram depicting the process of the airbag cushion 104 of FIG. 1(b) restraining the driver 166 in an oblique collision. Each of the diagrams in FIG. 6 correspond to the A-A cross-sectional view of the airbag cushion 104 in FIG. 1(b), depicting the airbag cushion 104 and the driver 166 as seen from above the vehicle.

FIG. 6(a) is a diagram depicting the appearance of the airbag cushion 104 immediately after expansion and deployment. As depicted in FIG. 6(a), when the vehicle is in an oblique collision, the airbag cushion 104 expands and deploys to the front of the driver seat 102 in the vehicle (see FIG. 1(b)).

FIG. 6(b) depicts a state of the driver 166 of FIG. 6(a) moving towards the front of the vehicle. There are cases where the driver 166 moves diagonally to the left in the vehicle width direction from the state of FIG. 6(a) due to inertia during an oblique collision.

FIG. 6(c) depicts a state of the driver 166 of FIG. 6(b) moving further towards the front of the vehicle. A driver 166 moving diagonally forward may bring, for example, the left shoulder into contact with the portion of the restraining surface 116 surrounding the recess part 120, and the left side of the head 168 will contact the inner wall of the recess part 120.

A restraining surface 116 that forms the recess part 120 can restrain the head 168 from the diagonal front by the inner wall of the recess part 120 while reducing tension around the recess part 120, as compared to a conventional restraining surface that extends in a planar shape. In this manner, the airbag cushion 104 can minimize the rotation 172 of the head 168 of the driver 166 relative to the shoulder 170 by using the recess part 120 without dislodging the driver 166, who moves diagonally in an oblique collision, and can restrain the movement of the head 168 and the movement of the shoulders 172 in a coordinated manner.

Therefore, in the present embodiment, the tether 122 pulls the restraining surface 116, enabling efficient formation of the recess part 120 that is recessed in the center of the restraining surface 116. The airbag cushion 104 not only serves to restrain the occupant during a normal collision, but also significantly reduces or eliminates the rotation 172 of the head 168 of the driver 166 during an oblique collision, thereby reducing the angular velocity of the head 168 and thus suppressing the injury level of the driver 166 associated with the rotation 172 of the head 168.

In the present embodiment, the recess part 120 is formed with a simple structure using the tether 122 and the side panel 132 made by a combination of a plurality of subpanels 132a to 132c. Therefore, with the present embodiment, the amount of materials used for the panels and the like is low enabling weight reduction and increase in material yield, thereby achieving low cost and further the airbag cushion 104 can also be folded and stowed in a more compact manner.

Note that with the description with reference to FIG. 6(c) described above, clockwise rotation was used as an example of rotation 172 that occurs with the head 168. However, depending on the conditions of the emergency, the driver 166 may move obliquely to the right in the vehicle width direction and the head 168 may rotate counterclockwise centered on the neck as viewed from above. The airbag cushion 104 of the present embodiment is able to reduce or eliminate rotation of the head 168 using the recess part 120 for this counterclockwise rotation as well and is able to reduce angular velocity of the head 168. In this manner, the airbag cushion 104 of the present embodiment is able to achieve the same effect regardless of which direction in the vehicle width direction the driver 166 moves towards.

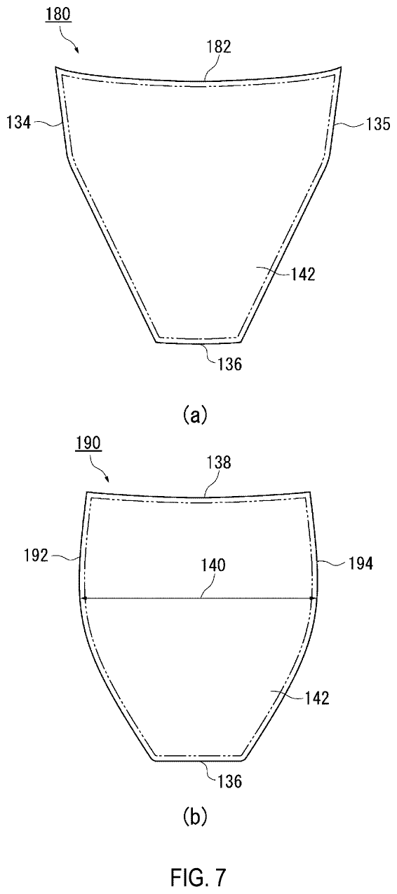

FIG. 7 is a diagram depicting a modified example of the subpanels 132a depicted in FIG. 4(d). FIG. 7(a) is a diagram depicting a subpanel 180 of the first modified example.

The subpanel 180 is widest at the second edge 182. With this configuration, an airbag cushion 104 can be achieved with a maximum diameter part 164 (see FIG. 5(b)) on the bottom surface 114 side, and can be inflated and deployed with a more stable posture. Furthermore, with this configuration, a side panel 132 (see FIG. 3(a)) having a narrower shape on the side of the restraining surface 116 can be suitably formed by connecting the side edges of a plurality of subpanels 180 together.

FIG. 7(b) is a diagram depicting a subpanel 190 of the second modified example. The subpanel 190 has curved side edges 192, 194.

The subpanel 190 has a curved configuration in which a pair of left and right side edges 192, 194 protrude in directions away from each other. Furthermore, a side panel 132 (see FIG. 3(a)) that can be inflated into a gentle curved shape can be achieved by combining a plurality of subpanels 190. Furthermore, a side panel 132 (see FIG. 3(a)) having a narrower shape on the side of the restraining surface 116 can be suitably formed by connecting the side edges of the subpanels 190 together.

In each of the above examples, the subpanels to be combined do not have to have the same shape, and may have a configuration divided into three or more parts. In either configuration, a side panel 132 (see FIG. 3(a)) that is narrower on the occupant side can be achieved by joining the side edges of the subpanels.

In the above examples, the technical concept of the airbag device 100 is embodied as a driver airbag. However, the airbag device 100 can also be embodied as, for example, a knee airbag. Even when the airbag device 100 is configured as a knee airbag, the knees of the occupant can be appropriately restrained from the front by the recess part using the tether, and can be protected from contact with the instrument panel, or the like. In addition, the airbag device 100 can also be used to restrain a rear seat occupant, for example by restraining the rear seat occupant from the front, thereby protecting the occupant from coming into contact with the front seat or from being thrown forward.

Preferred embodiments of the present invention were described with reference to the appended drawings, but it goes without saying that the present invention is not limited to such examples. It is clear that a person of ordinary skill in the art could conceive of various modifications or revisions within the scope set forth by the claims, and it would be understood that these modifications or revisions would belong to the technical scope of the present invention.

Moreover, the example in which the airbag device according to the present invention is applied to an automobile has been described in the embodiments described above. However, in addition to automobiles, the present invention can be applied to aircrafts, ships, and the like, with the same operation and effects capable of being achieved.

### INDUSTRIAL APPLICABILITY

The present invention can be used as a vehicle airbag device for restraining an occupant during an emergency.

### EXPLANATION OF CODES

100: Airbag device, 102: Driver seat, 104: Airbag cushion, 106: Steering wheel, 108: Rim, 110: Storage part, 112: Inflator, 114: Bottom surface, 116: Restraining surface, 118: Side surface, 120: Recess part, 122: Tether, 122a: First tether, 122b: Second tether, 122c: Third tether, 124: Bottom surface side panel, 126: Inner panel, 128: Composite panel, 130: Center panel, 132: Side panel, 132a to 132c: Subpanel 134, 135: Side edge, 136: First edge, 138: Second edge, 140: Intermediate portion, 142: Tapered region, 144: Main body, 146: Flange, 148: Stud bolt, 150: Base, 156: Securing region, 157a, 157b: Vent hole, 158: Securing region, 160a: Protruding part, 162: Base, 164: Maximum diameter part, 166: Driver, 168: Head, 170: Shoulder, 172: Rotation, 180: Subpanel, 182: Second edge, 190: Sub-panel, 192, 194: Side edge, L1: Dimension

1-10. (canceled)

11. A vehicle airbag device, containing an airbag cushion that is inflated and deployed between a structure in a vehicle cabin and an occupant seated in a seat in the event of an emergency, and an inflator that is installed on the structure, the airbag cushion comprising:
a bottom surface on the structure side;
a restraining surface on an occupant side;
a side surface connecting the bottom surface and the restraining surface; and
a recess part formed in a prescribed range at a center of the restraining surface recessed in the direction of the bottom surface;
wherein
a range extending from the side surface to at least a portion of the restraining surface is formed by a prescribed side panel;
the side panel includes a plurality of subpanels divided in a circumferential direction of the side surface;
each of the plurality of subpanels comprises:
a pair of side edges joined to adjacent subpanels;
a first edge on the restraining surface side; and
a second edge on the bottom surface side; and
the first edge is shorter than the second edge.

12. The vehicle airbag device according to claim 11, wherein the subpanel forms a region extending from the side surface to the recess part of the restraining surface.

13. The vehicle airbag device according to claim 11, wherein each of the plurality of subpanels is joined to an adjacent subpanel by sewing.

14. The vehicle airbag device according to claim 12, wherein each of the plurality of subpanels is joined to an adjacent subpanel by sewing.

15. The vehicle airbag device according to claim 11, wherein
the bottom surface of the airbag cushion is formed by a prescribed bottom surface side panel, and
the second edge is joined to an edge of the bottom surface side panel.

16. The vehicle airbag device according to claim 12, wherein
the bottom surface of the airbag cushion is formed by a prescribed bottom surface side panel, and
the second edge is joined to an edge of the bottom surface side panel.

17. The vehicle airbag device according to claim 15, wherein
the inflator is inserted into the airbag cushion with a portion penetrating the bottom surface side panel, and
the airbag cushion further includes a tether that pulls the recess part toward the inflator.

18. The vehicle airbag device according to claim 16, wherein
the inflator is inserted into the airbag cushion with a portion penetrating the bottom surface side panel, and
the airbag cushion further includes a tether that pulls the recess part toward the inflator.

19. The vehicle airbag device according to claim 17, wherein
a center bottom of the recess part of the airbag cushion is formed by a prescribed center panel, wherein
the first edge is joined to an edge of the center panel; and
the tether extends between the center panel and the inflator or a prescribed location in the periphery of the inflator.

20. The vehicle airbag device according to claim 18, wherein
a center bottom of the recess part of the airbag cushion is formed by a prescribed center panel, wherein
the first edge is joined to an edge of the center panel; and
the tether extends between the center panel and the inflator or a prescribed location in the periphery of the inflator.

21. The vehicle airbag device according to claim 19, wherein
the structure is a steering wheel of a vehicle;
the inflator is provided at a center proximal portion of the steering wheel; and
the airbag cushion is rolled or folded, and stored in the center proximal portion.

22. The vehicle airbag device according to claim 20, wherein
the structure is a steering wheel of a vehicle;
the inflator is provided at a center proximal portion of the steering wheel; and
the airbag cushion is rolled or folded, and stored in the center proximal portion.

23. The vehicle airbag device according to claim 11, wherein the pair of side edges of the subpanel are configured to protrude and curve in directions away from each other.

24. The vehicle airbag device according to claim 11, wherein the second edge of the subpanel is the widest.

25. The vehicle airbag device according to claim 11, wherein the sub-panel has a widest intermediate portion formed between the second edge and the first edge.
